(19) United States
(12) Patent Application Publication
(10) Pub. No.: US 2026/0113786 A1
(43) Pub. Date: Apr. 23, 2026

(54) CONTROL OF RANDOM ACCESS RESPONSE MONITORING FOR WIRELESS NETWORKS

(71) Applicant: Nokia Technologies Oy, Espoo (FI)

(72) Inventors: Timo KOSKELA, Oulu (FI); Juha Pekka KARJALAINEN, Oulu (FI); Sami-Jukka HAKOLA, Oulu (FI); Keeth Saliya Jayasinghe LADDU, Espoo (FI)

(21) Appl. No.: 19/175,622

(22) PCT Filed: Aug. 3, 2023
(86) PCT No.: PCT/EP2023/071517

§ 371 Date: Apr. 10, 2025

Related U.S. Application Data
(60) Provisional application No. 63/378,998, filed on Oct. 10, 2022.

(51) Int. Cl. H04W 74/0833; H04W 74/00

(52) U.S. Cl. CPC H04W 74/0833; H04W 74/006

(57) ABSTRACT

According to example embodiment, an apparatus includes at least one processor, and at least one memory storing instructions that, when executed by the at least one processor, cause the apparatus at least to: obtain a message instructing the apparatus to trigger or initiate a random access (RA) procedure to access a cell of a network device, the message indicating whether or not the apparatus is to monitor or receive a random access response (RAR) within a RA response window during the triggered random access procedure; and determine whether or not to monitor or receive the RAR within the RA response window based on the indication.

### TECHNICAL FIELD

This description relates to wireless communications.

### BACKGROUND

A communication system may be a facility that enables communication between two or more nodes or devices, such as fixed or mobile communication devices.

Signals can be carried on wired or wireless carriers.

An example of a cellular communication system is an architecture that is being standardized by the 3rd Generation Partnership Project (3GPP). A recent development in this field is often referred to as the long-term evolution (LTE) of the Universal Mobile Telecommunications System (UMTS) radio-access technology. E-UTRA (evolved UMTS Terrestrial Radio Access) is the air interface of 3GPP's Long Term Evolution (LTE) upgrade path for mobile networks. In LTE, base stations or access points (APs), which are referred to as enhanced Node AP (eNBs), provide wireless access within a coverage area or cell. In LTE, mobile devices, or mobile stations are referred to as user equipments (UE). LTE has included a number of improvements or developments. Aspects of LTE are also continuing to improve.

5G New Radio (NR) development is part of a continued mobile broadband evolution process to meet the requirements of 5G, similar to earlier evolution of 3G and 4G wireless networks. In addition, 5G is also targeted at the new emerging use cases in addition to mobile broadband. A goal of 5G is to provide significant improvement in wireless performance, which may include new levels of data rate, latency, reliability, and security. 5G NR may also scale to efficiently connect the massive Internet of Things (IoT) and may offer new types of mission-critical services. For example, ultra-reliable and low-latency communications (URLLC) devices may require high reliability and very low latency.

### SUMMARY

According to example embodiment, an apparatus includes at least one processor, and at least one memory storing instructions that, when executed by the at least one processor, cause the apparatus at least to: obtain a message instructing the apparatus to trigger or initiate a random access (RA) procedure to access a cell of a network device, the message indicating whether or not the apparatus is to monitor or receive a random access response (RAR) within a RA response window during the triggered random access procedure; and determine whether or not to monitor the RAR within the RA response window based on the indication.

According to an example embodiment, a method may include obtaining a message instructing the apparatus to trigger or initiate a random access (RA) procedure to access a cell of a network device, the message indicating whether or not the apparatus is to monitor or receive a random access response (RAR) within a RA response window during the triggered random access procedure; and determining whether or not to monitor the RAR within the RA response window based on the indication.

According to an example embodiment, an apparatus may include means for obtaining, by a user device, a message instructing the user device to trigger or initiate a random access (RA) procedure to access a cell of a network device, the message indicating whether or not the apparatus is to monitor or receive a random access response (RAR) within a RA response window during the triggered random access procedure; and means for determining, by the user device, whether or not to monitor the RAR within the RA response window based on the indication.

According to an example embodiment, a non-transitory computer-readable storage medium includes instructions stored thereon that, when executed by at least one processor, are configured to cause a computing system to: obtain a message instructing the apparatus to trigger or initiate a random access (RA) procedure to access a cell of a network device, the message indicating whether or not the apparatus is to monitor or receive a random access response (RAR) within a RA response window during the triggered random access procedure; and determine whether or not to monitor the RAR within the RA response window based on the indication.

The details of one or more examples of embodiments are set forth in the accompanying drawings and the description below. Other features will be apparent from the description and drawings, and from the claims.

### BRIEF DESCRIPTION OF THE DRAWINGS

FIG. 1 is a block diagram of a wireless network according to an example embodiment.

FIG. 2A is a diagram illustrating operations of a 4-step random access (RACH) procedure according to an example embodiment.

FIG. 2B is a diagram illustrating operations of a 2-step random access (RACH) procedure according to an example embodiment.

FIG. 3 is a diagram illustrating a plurality of candidate target cells according to an example embodiment.

FIG. 4 is a diagram illustrating a random access response window according to an example embodiment.

FIG. 5 is a flow chart illustrating operation of a user device (or UE) according to an example embodiment.

FIG. 6 is a block diagram of a wireless station or node (e.g., network node network device, user node, user device, UE, relay node, or other node).

### DETAILED DESCRIPTION

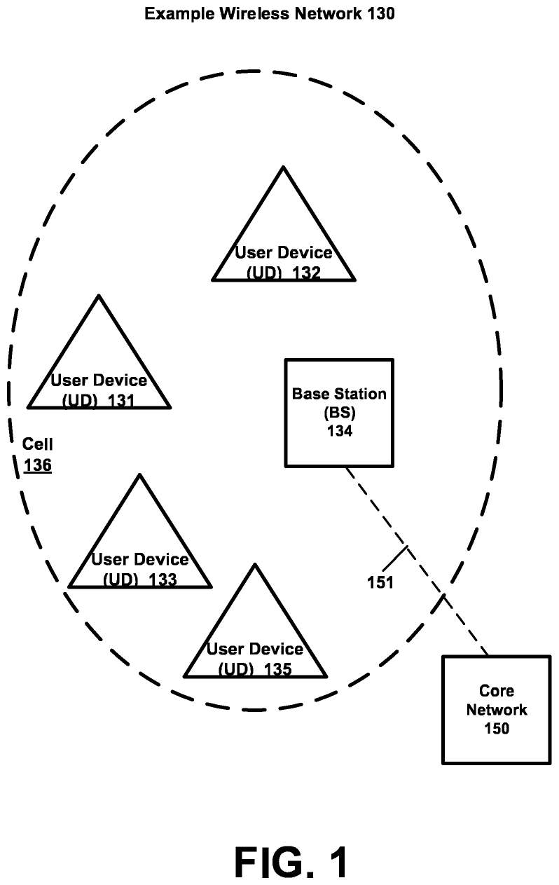

FIG. 1 is a block diagram of a wireless network 130 according to an example embodiment. In the wireless network 130 of FIG. 1, user devices 131, 132, 133 and 135, which may also be referred to as mobile stations (MSs) or user equipment (UEs), may be connected (and in communication) with a base station (BS) 134, which may also be referred to as an access point (AP), an enhanced Node B (eNB), a gNB or a network node. The terms user device and user equipment (UE) may be used interchangeably. A BS may also include or may be referred to as a RAN (radio access network) node, and may include a portion of a BS or a portion of a RAN node, such as (e.g., such as a centralized unit (CU) and/or a distributed unit (DU) in the case of a split BS or split gNB). At least part of the functionalities of a BS (e.g., access point (AP), base station (BS) or (e) Node B (eNB), gNB, RAN node) may also be carried out by any node, server or host which may be operably coupled to a transceiver, such as a remote radio head. BS (or AP) 134 provides wireless coverage within a cell 136, including to user devices (or UEs) 131, 132, 133 and 135. Although only four user devices (or UEs) are shown as being connected or attached to BS 134, any number of user devices may be provided. BS 134 is also connected to a core network 150 via a S1 interface 151. This is merely one simple example of a wireless network, and others may be used.

A base station (e.g., such as BS 134) is an example of a radio access network (RAN) node within a wireless network. A BS (or a RAN node) may be or may include (or may alternatively be referred to as), e.g., an access point (AP), a gNB, an eNB, or portion thereof (such as a/centralized unit (CU) and/or a distributed unit (DU) in the case of a split BS or split gNB), or other network node.

According to an illustrative example, a BS node (e.g., BS, CNB, gNB, CU/DU, . . . ) or a radio access network (RAN) may be part of a mobile telecommunication system. A RAN (radio access network) may include one or more BSs or RAN nodes that implement a radio access technology, e.g., to allow one or more UEs to have access to a network or core network. Thus, for example, the RAN (RAN nodes, such as BSs or gNBs) may reside between one or more user devices or UEs and a core network. According to an example embodiment, each RAN node (e.g., BS, eNB, gNB, CU/DU, . . . ) or BS may provide one or more wireless communication services for one or more UEs or user devices, e.g., to allow the UEs to have wireless access to a network, via the RAN node. Each RAN node or BS may perform or provide wireless communication services, e.g., such as allowing UEs or user devices to establish a wireless connection to the RAN node, and sending data to and/or receiving data from one or more of the UEs. For example, after establishing a connection to a UE, a RAN node or network node (e.g., BS, eNB, gNB, CU/DU, . . . ) may forward data to the UE that is received from a network or the core network, and/or forward data received from the UE to the network or core network. RAN nodes or network nodes (e.g., BS, eNB, gNB, CU/DU, . . . ) may perform a wide variety of other wireless functions or services, e.g., such as broadcasting control information (e.g., such as system information or on-demand system information) to UEs, paging UEs when there is data to be delivered to the UE, assisting in handover of a UE between cells, scheduling of resources for uplink data transmission from the UE(s) and downlink data transmission to UE(s), sending control information to configure one or more UEs, and the like. These are a few examples of one or more functions that a RAN node or BS may perform.

A user device or user node (user terminal, user equipment (UE), mobile terminal, handheld wireless device, etc.) may refer to a portable computing device that includes wireless mobile communication devices operating either with or without a subscriber identification module (SIM), including, but not limited to, the following types of devices: a mobile station (MS), a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, a vehicle, a sensor, and a multimedia device, as examples, or any other wireless device. It should be appreciated that a user device may also be (or may include) a nearly exclusive uplink only device, of which an example is a camera or video camera loading images or video clips to a network. Also, a user node may include a user equipment (UE), a user device, a user terminal, a mobile terminal, a mobile station, a mobile node, a subscriber device, a subscriber node, a subscriber terminal, or other user node. For example, a user node may be used for wireless communications with one or more network nodes (e.g., gNB, CNB, BS, AP, CU, DU, CU/DU) and/or with one or more other user nodes, regardless of the technology or radio access technology (RAT). In LTE (as an illustrative example), core network 150 may be referred to as Evolved Packet Core (EPC), which may include a mobility management entity (MME) which may handle or assist with mobility/handover of user devices between BSs, one or more gateways that may forward data and control signals between the BSs and packet data networks or the Internet, and other control functions or blocks. Other types of wireless networks, such as 5G (which may be referred to as New Radio (NR)) may also include a core network.

In addition, the techniques described herein may be applied to various types of user devices or data service types, or may apply to user devices that may have multiple applications running thereon that may be of different data service types. New Radio (5G) development may support a number of different applications or a number of different data service types, such as for example: machine type communications (MTC), enhanced machine type communication (eMTC), Internet of Things (IoT), and/or narrowband IoT user devices, enhanced mobile broadband (eMBB), and ultra-reliable and low-latency communications (URLLC). Many of these new 5G (NR)—related applications may require generally higher performance than previous wireless networks.

IoT may refer to an ever-growing group of objects that may have Internet or network connectivity, so that these objects may send information to and receive information from other network devices. For example, many sensor type applications or devices may monitor a physical condition or a status, and may send a report to a server or other network device, e.g., when an event occurs. Machine Type Communications (MTC, or Machine to Machine communications) may, for example, be characterized by fully automatic data generation, exchange, processing and actuation among intelligent machines, with or without intervention of humans. Enhanced mobile broadband (eMBB) may support much higher data rates than currently available in LTE.

Ultra-reliable and low-latency communications (URLLC) is a new data service type, or new usage scenario, which may be supported for New Radio (5G) systems. This enables emerging new applications and services, such as industrial automations, autonomous driving, vehicular safety, e-health services, and so on. 3GPP targets in providing connectivity with reliability corresponding to block error rate (BLER) of 10-5 and up to 1 ms U-Plane (user/data plane) latency, by way of illustrative example. Thus, for example, URLLC user devices/UEs may require a significantly lower block error rate than other types of user devices/UEs as well as low latency (with or without requirement for simultaneous high reliability). Thus, for example, a URLLC UE (or URLLC application on a UE) may require much shorter latency, as compared to an eMBB UE (or an eMBB application running on a UE).

The techniques described herein may be applied to a wide variety of wireless technologies or wireless networks, such as LTE, LTE-A, 5G (New Radio (NR)), cmWave, and/or mmWave band networks, IoT, MTC, eMTC, eMBB, URLLC, etc., or any other wireless network or wireless technology. These example networks, technologies or data service types are provided only as illustrative examples.

At least in some example cases, a UE may be in one of multiple states (e.g., such as one of three Radio Resource Control (RRC) states) with respect to a network node or gNB. In an Idle state (RRC Idle), there is typically no (or limited) RRC context (where a RRC context may include information or parameters necessary for communication between the UE and gNB/network node) stored in the RAN (radio access network) node (e.g., gNB) or network node, or UE, and the UE does not belong (or is not connected to) to a specific cell. From a core network perspective, the Idle UE is in an Idle (CM_Idle) state. No data transfer may typically occur between a UE and network node (e.g., gNB) when the UE is in an Idle state, as the UE sleeps (in a low power state) most of the time to conserve power. In an Idle state, a UE may typically periodically wake up to receive paging messages from the network.

A UE may transition from Idle state (e.g., RRC Idle) to a Connected state (e.g., RRC Connected state, where the UE is connected to the network node) by performing a random access (RACH) procedure with the gNB or network node. As part of the RACH procedure, both the UE and network node (e.g., gNB) may obtain the context, e.g., communication parameters necessary to allow UE-gNB communication. As an example communication parameter, the UE may obtain, e.g., as part of a RACH procedure with gNB or network node, a timing advance to allow the UE to perform uplink transmission to the gNB. The UE may also obtain a UE identity from the network, e.g., such as a cell-radio network temporary identifier (C-RNTI), which may be used by the UE for communication or signalling with the network or gNB. In a connected state (e.g., RRC Connected) with respect to a cell (or gNB or DU), the UE is connected to a gNB or network node, and the UE may receive data, and may send data (e.g., based on receiving an uplink grant).

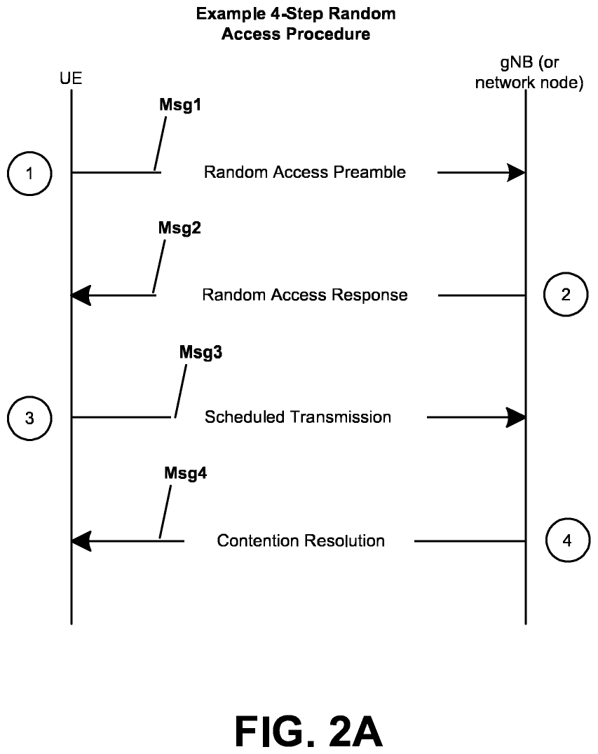

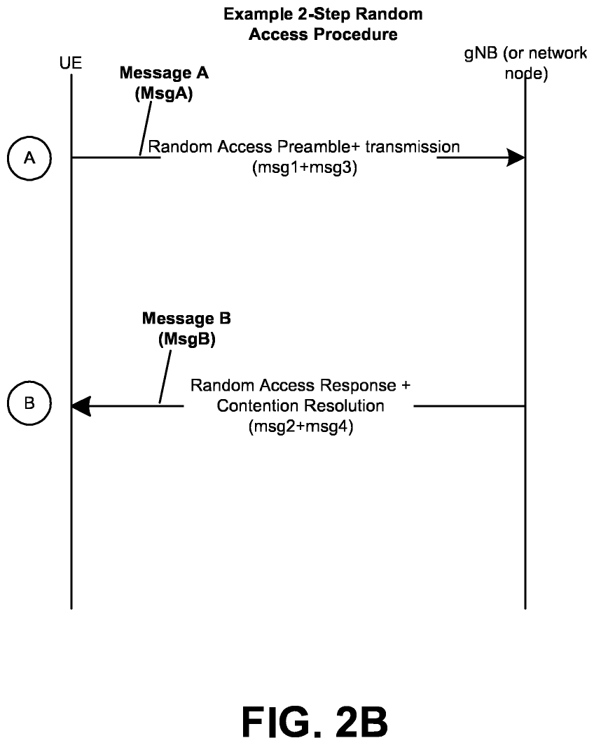

FIG. 2A is a diagram illustrating operations of a 4-step random access (RACH) procedure according to an example embodiment. When the RACH procedure is triggered (caused to be performed by the UE), the UE sends a random access (RACH) preamble over the random access (RACH) channel (Step 1), or Msg1 (message 1). There are different groups of preambles defined or configured, depending on the size of Msg3 (message 3) and based on the UE's channel conditions. The UE obtains information on how to access the RACH channel from system information block 1 (SIB1) broadcasted in the system information (S1) from the gNB. After receiving message 1 (random access preamble from the UE), the gNB determines the receive timing of the received random access preamble. Based on the receive timing of the received preamble (if there are no collisions with other UEs), the gNB determines a timing advance (or TA or timing advance command) to adjust the timing of the UE uplink frame to align with a downlink frame (and also to align uplink receive timing with other UE uplink frames). Because each UE may be provided at a different location, each UE may have a different radio propagation delay, and thus a different or specific timing advance with respect to a gNB.

As shown in FIG. 2A, at Step 2 (Msg2 or message 2), the gNB responds to the UE with a random access response (RAR), which may include an index to (or identifier of) the received random access (or RACH) preamble (index or identifier of a random access preamble resource) (also known as RAPID or random access preamble identifier), the timing advance (TA, or timing advance command), a temporary cell-radio network temporary identifier (TC-RNTI) assigned to the UE, and an uplink (UL) grant (e.g., including scheduling information and/or information indicating resources to be used for UL transmission) to be used by the UE for uplink transmission of message 3 (Msg3). Upon receiving the RAR message (Msg2), the UE can send the first uplink transmission to the network (Msg3 or message 3). The size of the transmission of Msg3 depends on the grant received at step 2 (Msg2 or message 2). Step 4 (Msg 4 or message 4) may include transmission of a DL message from gNB to UE that involves the contention resolution phase. After a UE is connected to a gNB (e.g., after the random access procedure is completed), the UE may receive an updated timing advance (TA) value or TA command from the serving gNB or serving cell.

Furthermore, as an alternative RACH procedure, a 2-step RACH (random access) procedure may be used to provide a faster random access procedure. FIG. 2B is a diagram illustrating operations of a 2-step random access (RACH) procedure according to an example embodiment. At message A (MsgA), a UE may transmit a message that includes contents of both Msg1 and Msg3 as a first message (MsgA) of the 2-step RACH procedure. And, for example, the network node or gNB may transmit Msg2 and Msg4 as a second message (or MsgB or message B) of the 2-step RACH procedure.

A timing advance group (TAG) may include one or more serving cells with the same uplink TA and a same downlink timing reference cell. Each TAG may include one serving cell with a configured uplink, and the mapping of each serving cell to a TAG may be configured by gNB, e.g., via a radio resource control (RRC) message. A TAG field in a MAC CE may refer to the TAG identifier (or TAG ID) specified in the RRC message.

A gNB or network node may trigger or cause a UE to perform a random access procedure to a specific cell by sending a physical downlink control channel (PDCCH) order. The PDCCH order may include, e.g., a physical cell identity (PCI) of the cell to which the UE should perform random access, and a random access preamble resource identifier (e.g., random access preamble index or identifier) that the UE should use (e.g., transmit as Msg1 to the cell) to perform random access to the indicated cell.

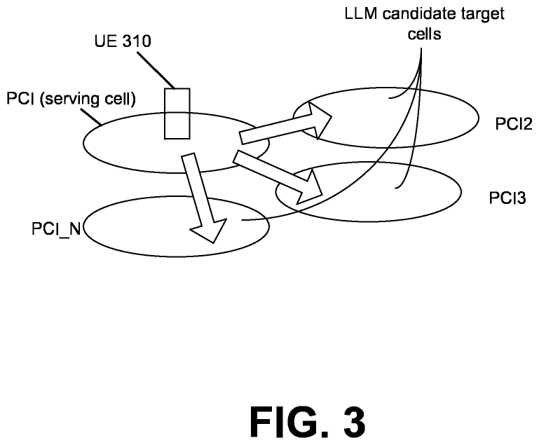

A UE may perform a cell change from one cell to another cell. A UE may sometimes have a plurality of candidate target cells (to which the UE may perform a cell change or handover), to which a cell change (or handover) may be performed. FIG. 3 is a diagram illustrating a plurality of candidate target cells according to an example embodiment. A UE 310 may be served by a serving cell (e.g., serving cell having a physical cell identity (PCI) of PCI_1), but may have a plurality of candidate target cells, including candidate target cells with physical cell identities (PCIs) PCI_2, PCI_3, . . . . PCI_N.

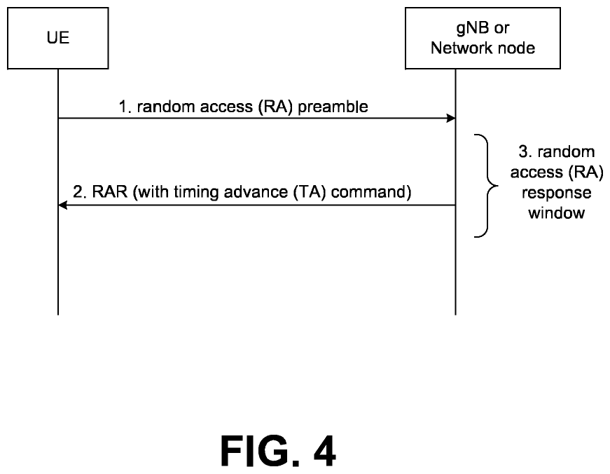

However, after a UE cell change has been triggered to a target cell, a delay in uplink communication may typically occur while the UE performs random access to the target cell to acquire an uplink timing advance (TA). FIG. 4 is a diagram illustrating a random access response window according to an example embodiment. At 1, the UE may transmit a random access preamble to the target cell. At 2, the gNB may transmit a message 2 including a random access response (RAR), which includes the TA value for the UE. The UE may typically receive the RAR during the random access response window (3). The UE will typically not transmit or receive during the random access response (RAR) window, as it will detect, monitor and/or receive the RAR during the RAR window (3). However, if the UE is performing random access to each of the candidate target cells to receive a TA value from each of the candidate target cells, this may create significant overhead for the UE and reduce periods of time when the UE could otherwise be transmitting or receiving data or other signals.

Various example techniques and/or embodiments are disclosed that may allow a UE to determine whether it should monitor or receive a random access response from a cell (e.g., a candidate target cell). For example, a UE may obtain (e.g., receive) a message (e.g., downlink control information (DCI) and/or a PDCCH order) from a network device or network node (e.g., gNB) instructing the UE to trigger or initiate a random access (RA) procedure to access a cell of a network device. The message may indicate whether or not the UE is to monitor or receive a random access response (RAR) within a RA response window during the triggered random access procedure. For example, if the message indicates that the UE is to monitor or receive a RA response within the RA response window, then the UE will monitor and receive (or attempt to receive) a RAR within the RA response window for the triggered random access response procedure. If a RAR is monitored and received by the UE, the UE may transmit an indication to the network device or serving cell indicating that a random access procedure has been performed (and/or a TA value has been received from) the cell (e.g., with the candidate target cell). Otherwise, if the message (e.g., DCI and/or PDCCH order) indicates that the UE is not required to monitor or receive a RA response within the RA response window for the triggered random access procedure, the UE may (or will) omit monitoring and/or receiving a random access response (RAR) for the triggered random access response, and the UE may determine or assume that the triggered random access procedure is successfully completed after a RA preamble transmission from the UE to the cell of the network device for the triggered random access procedure.

In an example embodiment, the message (e.g., the DCI and/or PDCCH order) obtained by the UE may indicate, either explicitly or implicitly, whether or not the UE is to monitor or receive a random access response (RAR) within a RA response window during the triggered random access procedure. For example, the message (e.g., DCI and/or PDCCH order) may include a field (e.g., bit, set of bits, codepoint value or table lookup value) set to a value to explicitly indicate to the UE whether or not the UE is to monitor or receive a random access response (RAR) within a RA response window during the triggered random access procedure. Thus, the message may include a field to explicitly indicate whether or not the UE is to monitor or receive a random access response (RAR) within a RA response window during the triggered random access procedure. As an example of an explicit indication, the field within the message may be set to a first value to indicate the UE should monitor or receive the RAR for the triggered RA procedure, while the field may be set to a second value to indicate that the UE should not monitor or receive the RAR for the triggered RA procedure.

In some embodiments, UE may (or may be configured to) monitor RAR for the triggered RA procedure and upon successful completion of the procedure it may be further configured to communicate (e.g., indicate the success and/or the obtained TA value) with the cell that triggered the procedure.

In some example embodiments, UE may receive an explicit indication (DCI and/or PDCCH order) that indicates whether or not it should/is required to monitor a response to the transmission of a preamble. In one example UE may receive an indication to monitor or receive the DCI (transmitted as a response to the RA preamble, and that may schedule the RAR message) but it is not required or the UE does not expect to receive the RAR or it does not expect to be scheduled by the DCI a PDSCH (physical downlink shared channel) providing the RAR.

Alternatively, as an example of an implicit indication of whether or not the UE should monitor or receive the RAR, the message (e.g., DCI and/or PDCCH order) may include or may indicate a random access preamble resource (e.g., the message may indicate a RA preamble identifier or RA preamble index) associated with monitoring or receiving a random access response (RAR) within the RA response window during the triggered random access procedure, or the message may indicate a random access preamble resource (e.g., indicate a RA preamble identifier or RA preamble index) associated with Not monitoring or receiving a random access response (RAR) within the RA response window during the triggered random access procedure. For example, a first list of random access preamble resources may be associated with monitoring or receiving a random access response (RAR) within a random access (RA) response window during a triggered random access procedure, and a second list of random access preamble resources may be associated with not monitoring or receiving a random access response (RAR) within a random access (RA) response window during a triggered random access procedure. Thus, the message may indicate a first RA preamble resource from the first list of random access preambles to (e.g., implicitly) indicate to the UE that the UE is to (or should) monitor or receive a random access response (RAR) within a random access (RA) response window during the triggered random access procedure. Or, the message may indicate a second RA preamble resource from the second list of random access preambles to (e.g., implicitly) indicate to the UE that the UE is to (or should) monitor or receive a random access response (RAR) within a random access (RA) response window during the triggered random access procedure. Also, according to an example embodiment, e.g., such as in a case where the UE does not monitor or receive a RA response from a cell (e.g., from a candidate target cell or a serving cell), such candidate target cell may receive the RA preamble transmitted (as message 1 of a (e.g., partial) random access procedure) by the UE, and the candidate cell may determine or estimate a timing advance (TA) value or TA command for the UE, and may forward such TA value to the network device or serving (or source) cell. The network device (network node) or serving cell or source cell for the UE may receive TA values for the UE from one or more (e.g., multiple) candidate target cells (e.g., based on RA preambles transmitted by the UE to each of these candidate target cells), and the network device or serving (or source) cell may forward these one or more TA values (estimated for the UE) to the UE. For example, at least in some cases, this may provide a more efficient technique for the UE to obtain TA values from (or with respect to) multiple candidate target cells, without the UE necessarily needing to perform a full random access procedure (including monitoring and receiving a TA value from each of the candidate target cells).

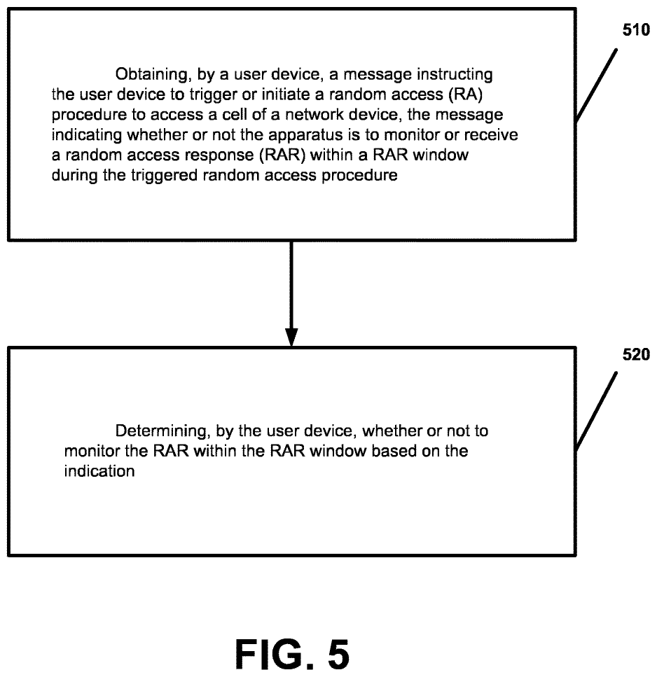

FIG. 5 is a flow chart illustrating operation of a user device (or UE) according to an example embodiment. Operation 510 includes obtaining, by a user device, a message instructing the user device to trigger or initiate a random access (RA) procedure to access a cell of a network device, the message indicating whether or not the apparatus is to monitor or receive a random access response (RAR) within a RA response window during the triggered random access procedure. Operation 520 includes determining, by the user device, whether or not to monitor the RAR within the RA response window based on the indication.

With respect to the method of FIG. 5, the message may include a downlink control information (DCI) received via a physical downlink control channel (PDCCH).

With respect to the method of FIG. 5, the message may include a field triggering or causing a physical downlink control channel (PDCCH) order that indicates whether or not the apparatus is monitor or receive the RAR response within the RA response window during the triggered random access procedure initiated via the PDCCH order. In one example, the PDCCH order may include of one or more preamble index (or one or more preamble index+PCI pair(s)). In a further example, one PDCCH order (a DCI message) may trigger one or more RA procedures for which UE may be indicated (may receive an indication of) whether or not to monitor RA response. The indication whether or not to monitor the RA response may be indicated per preamble index (or preamble index+PCI pair). Alternatively, an indication whether or not to monitor may be applied for all the preamble indices (or preamble+PCI) listed in the PDCCH order. The UE, upon receiving a PDCCH order comprising a list of one or more preamble index values, may trigger one or more RA procedures (and complete the procedures as described herein) to transmit a RA preamble for each of the RA preamble indices listed in the PDCCH order. UE may initiate/trigger RA procedures in sequence of the listed preamble indices, or it may trigger the in UE selected (or random) order. In one example, the PDCCH order may include/comprise a pointer, e.g., a bit value that is associated with a configured set/list of pre-configured ra-preamble index values (+PCI) that are triggered by the PDCCH order. This list may be configured, e.g., using RRC (or RRC+MAC CE, or MAC CE) signaling.

In some examples, the PCI value listed in the PDCCH order (or in a RRC configuration related to the PDCCH order), may be a reindexed value of a full PCI value. For example, the actual PCI value (e.g., 10 bits) may be mapped to a shorter re-indexed PCI value wherein the re-indexed value may be signaled, e.g., using a lower number of bits (e.g., 3 bits). This saves the amount of signaled bits, for example.

With respect to the method of FIG. 5, the field may include at least one of: 1 bit, N bit, a codepoint value, or a value that is used as a table lookup, where N is a positive integer. With respect to the method of FIG. 5, the method may include: if the message indicates that the apparatus is not to monitor or receive the RAR within the RA response (RAR) window during the triggered random access procedure, determining or assuming, by the apparatus, that the triggered random access procedure is successfully completed after a RA preamble transmission from the apparatus to the cell of the network device for the triggered random access procedure.

With respect to the method of FIG. 5, the method may include: if the indication indicates that a random access preamble resource is configured not to be associated with the RAR, determining or assuming that the triggered random access procedure is successfully completed after a random access (RA) preamble transmission corresponding to the random access preamble resource from the apparatus to the cell of the network device for the triggered random access procedure.

With respect to the method of FIG. 5, the method may include: obtaining a downlink reference signal (DL RS) indicated in the PDCCH order (DL RS may be obtained/determined through the association with the RA preamble); and determining, based on the DL RS, whether or not the random access response (RAR) is configured to be monitored or received by the apparatus (or UE) within the RAR window for the triggered random access procedure.

With respect to the method of FIG. 5, the method may include: storing a resource associated with the downlink reference signal (DL) RS in a list of downlink resources.

With respect to the method of FIG. 5, the list of downlink resources may include one or more timing advance (TA) references or values.

With respect to the method of FIG. 5, wherein a size of the list of downlink resources is predefined or configured by the network device.

With respect to the method of FIG. 5, the list of downlink resources each is associated with a corresponding physical cell identity (PCI) value.

With respect to the method of FIG. 5, the method may include: the list of downlink resources each is associated with a corresponding validity timer.

With respect to the method of FIG. 5, a maximum value of each of the validity timers is predefined or configured by the network device.

With respect to the method of FIG. 5, the validity timers each are started after successful completion of the triggered random access procedure.

With respect to the method of FIG. 5, the method may include: if the indication indicates that the apparatus is not to monitor or receive the RAR within the RAR window for the triggered random access procedure, acquiring a timing advance (TA) value associated with at least one downlink resource in the list of downlink resources for the triggered random access procedure.

With respect to the method of FIG. 5, the acquired timing advance (TA) value is different from a TA value currently in use in the cell of the network device for the triggered random access procedure.

With respect to the method of FIG. 5, the method may include: upon acquiring the timing advance (TA) value, performing one or more subsequent uplink transmissions to the cell of the network device in accordance with the acquired TA value.

With respect to the method of FIG. 5, the method may include: if the indication indicates that the downlink control information (DCI) triggers or causes the PDCCH order and a target downlink reference signal (DL RS) for the random access (RA) preamble transmission is associated with a different cell of the network device, indicating to the cell of the network device, a successful completion of the triggered random access procedure.

With respect to the method of FIG. 5, the method may include: if the physical downlink control channel (PDCCH) order indicates the apparatus to monitor or receive the random access response (RAR) for the random access (RA) preamble transmission, determining whether to report, to the cell of the network device, a successful completion of the triggered random access procedure.

With respect to the method of FIG. 5, the method may include: indicating, to the cell of the network device, one or more physical cell identities (PCIs) for which at least one of the RA procedure triggered by PDCCH order is completed or a timing advance (TA) value is received.

With respect to the method of FIG. 5, the one or more physical cell identities (PCIs) are indicated via a media access control-control element (MAC-CE).

With respect to the method of FIG. 5, the message may include: a random access preamble resource; and a physical downlink control channel (PDCCH) order instructing the apparatus to perform the triggered random access procedure; wherein the PDCCH order indicates, either explicitly or implicitly, whether or not the apparatus is to monitor or receive a random access response (RAR) within a RA response window during the triggered random access procedure.

With respect to the method of FIG. 5, the PDCCH order includes a field set to a value to explicitly indicate whether or not the apparatus is to monitor or receive a random access response (RAR) within a RA response window during the triggered random access procedure.

With respect to the method of FIG. 5, a first list of random access preamble resources are associated with monitoring or receiving a random access response (RAR) within a random access (RA) response window during the triggered random access procedure; and a second list of random access preamble resources are associated with not monitoring or receiving a random access response (RAR) within a random access (RA) response window during the triggered random access procedure; and wherein the message includes a random access preamble resource from the second list of random access preambles to implicitly indicate that the apparatus is not to monitor or receive a random access response (RAR) within a random access (RA) response window during the triggered random access procedure.

According to an example embodiment, a UE may receive a downlink (DL) message, such as a PDCCH order, which may: 1) request the UE to perform a random access (RA) procedure to a particular target candidate cell, and identifies the RA preamble resource the UE should use to transmit RA preamble, and 2) the RA preamble may be associated with a target DL reference signal for that cell (e.g., SSB or CSI RS), and 3) the PDCCH order may include information indicating whether or not UE should monitor or receive a RAR for that RA procedure.

The UE may typically monitor DL RS associated with the RA preamble resource, e.g., to estimate timing so UE may transmit RA preamble using the estimated UL timing. UE transmits RA preamble on configured RA preamble resource, and UE may select the best UE beam based on the DL RS. Thus, the UE may receive the DL reference signal associated with the RA preamble, e.g., to select UE beam to transmit preamble, and to obtain DL timing (symbol timing and timing reference for UL transmission) to be used for uplink (UL) transmission of the RA preamble using same timing.

After UE receives this PDCCH order, UE identifies the RA preamble resource, which is associated with Target cell (target cell may also be the serving cell) DL RS, and UE selects a beam for UE UL RA preamble transmission and determines timing (for UL transmission of RA preamble) based on DL RS. UE transmits the RA preamble. And, according to an example embodiment, the message (e.g., PDCCH order) received by the UE may indicate whether or not the UE is to monitor or receive a random access response (RAR) within a RA response window during the triggered random access procedure.

In one embodiment, a field in a DCI message triggering a PDCCH order may indicate whether or not UE is to (or should or is required to) monitor and receive a RAR for the triggered random access procedure. Also, for example, this field in the DCI message or PDCCH order may indicate whether or not the UE is assumed to receive (or will receive) a RAR response for the random access procedure initiated by the PDCCH order. The DCI message scheduling the PDCCH order may include a field (e.g., 1 bit or N bit, or a codepoint value or a value for a table lookup, that indicates whether or not the UE is configured to monitor RA response window for the RA response for the triggered random access preamble transmission. Based on value of this field, the UE may then monitor and receive (or not monitor and not receive) the RAR for the triggered RA procedure the UE initiated based on PDCCH order.

In some cases, a network device or network node may later send UE with a TA (for same cell it is connected to, or a TA for another cell, such as a candidate target cell(s)), if the UE UL timing needs to be updated for those cells.

Also, according to an example embodiment, the UE may receive a timing advance (TA) outside of the random access procedure (e.g., a TA forwarded by a serving cell or source cell or network device to the UE, which may have been received by network device or serving cell from a candidate target cell), for one or more candidate target cells. In one embodiment, if the DCI (triggering the PDCCH order) indicates that the UE is not configured (or assumed or activated or indicated) to monitor or receive the RA response for that random access procedure, the UE shall assume that the random access procedure is successfully completed after the UE has transmitted the RA preamble (and thus, there is no need for UE to monitor or receive the RAR for that random access procedure). In this case, the network (e.g., network device or node, or serving cell or source cell) may receive the UE transmission (the transmitted preamble) and determine whether a (new) TA value should be used/and/or provided for at least one of the cells (that may be covered by one or more DL RS, that may be associated with one or more TRPs).

Alternatively, a cell (e.g., a candidate target cell/serving cell/a cell to which the UE transmitted a RA preamble) receiving the RA preamble, e.g., configured for inter cell beam management (or lower layer mobility), may provide (or send to) the serving cell or network device or network node, information on the TA value that was detected or observed by the candidate target cell based on the UE transmission of the RA preamble. Thus, although the UE may not monitor or receive the RAR, including a TA value, the candidate target cell may send (e.g., an estimate of) the TA value for the UE (based on the received RA preamble) to the serving cell, source cell or network device (e.g., gNB that serves the UE). In one example, the serving cell may negotiate (e.g., request or indicate) with one or more candidate target cells to determine and/or indicate that a specific RA preamble resources or transmissions that do not require RA response. For example, since the RA transmission is performed using the RA resources of the target cell, the cells may negotiate which resources can be used for RA transmission. A candidate target cell (to which the UE transmitted the RA preamble) may determine a TA value, and then may transmit this TA value for the UE to serving cell of UE. As noted, the UE can transmit RA preambles to multiple candidate target cells, e.g., based on different/multiple PDCCH orders (or based on multiple orders within PDCCH order or within one DCI), and candidate target cells may determine a TA value for the UE and send that TA value to the serving cell. Thus, for example, candidate target cells may receive a RA preamble, determine a TA value for the UE, and then report these TA values for the UE to a serving cell, source cell, or network device (or network node). The serving cell or source cell or network device or network node controlling the serving cell may then forward a group of these TAs to the UE, which may be a much more efficient technique for the UE to obtain TA values for multiple candidate target cells, as compared to monitoring and receiving and RAR and TA from each of these candidate target cells.

In one embodiment, a random access preamble resource may be configured not to be associated with monitoring of RA response. If the DCI (triggering the PDCCH order) indicates a random access resource which is configured not to be associated with a random access response, the UE shall assume that the random access procedure is successfully completed after UE has transmitted the RA preamble (and thus, in such case, the UE will not monitor or receive the RAR of that triggered random access procedure). Instead of PDCCH order explicitly indicating to monitor and receive (or not monitor and not receive) the RAR for a triggered random access procedure, the RA preamble resource indicated in the PDCCH order may implicitly indicate whether or not the UE is to monitor and receive the RAR for this random access procedure. For example, a first list of random access preamble resources may be associated with monitoring or receiving a random access response (RAR) within a random access (RA) response window during the triggered random access procedure, and a second list of random access preamble resources are associated with not monitoring or receiving a random access response (RAR) within a random access (RA) response window during the triggered random access procedure.

Thus, for example, the message (e.g., PDCCH order or DCI) may indicate or identify a random access preamble resource (e.g., a random access preamble index or identifier) from the second list of random access preambles to implicitly indicate to the UE that the UE is not to monitor or receive a random access response (RAR) within a random access (RA) response window during the triggered random access procedure. Thus, there may be a set of RA preambles requiring RAR monitoring, and another set of RA preambles for which RAR is not to be monitored or received, and the UE may be notified by which type of RA preamble (or based on a preamble provided from either the first list or the second list of RA preambles) is received within PDCCH order. Thus, there may be different techniques that may be used by network device or serving cell to notify the UE whether or not it should monitor and receive the RAR for the random access procedure.

A DL RS may be indicated via indication of the RA preamble resource within PDCCH order. UE may store or maintain a list of DL RSs that were indicated via the preamble(s) indicated in the PDCCH order (DL RS associated with indicated RA preamble) where it was configured not to monitor the RAR. Both UE and network device may store or maintain this list of DL RSs, associated with specific RA preambles, and network device may associate one or more DL RSs with a TA value.

As an example: a PDCCH order 1—may indicate, do not monitor RA for cell 1; indicates RA preamble index 1 associated with DL RS1. A network device or serving cell may later inform (MAC CE on PDCCH) UE this is the TAI for this DL RS1. UE may add the DL RS1 and associated TAI to its list, or UE may associate the DL RS1 with TAI, used for cell 1 communication. Also, for example, UE may receive PDCCH order 2, which indicates do not monitor for cell 2, where PDCCH order indicates the RA preamble index (associated with a specific resource). For example, this PDCCH order 2 may indicate a RA preamble index 2, and indicating a RA preamble resource associated with DL RS2 and cell 2. A PCI/cell ID may be included in each PDCCH order. UE now has the TA for these cells, in the event UE performs a cell change to any of these cells. UE performs cell change to a candidate target cell. UE may have previously obtained or received the TA for such candidate target cell, and thus UE does not need to perform RA procedure as part of cell change to obtain TA for such candidate target cell. After cell change is initiated, the UE can change its beam and UE has TA for UL transmission, without waiting to perform random access procedure.

In an example embodiment, the UE may keep track (e.g., UE may keep or store a list) of which cells the network (e.g., network device, network node or serving cell or source cell) triggered the PDCCH order for the UE, and then UE may later receive the TA values for those cells, e.g., from a network device or network node, the serving cell or source cell, for example. For example, the DL RS (or PCI or DL-RS+PCI) that was indicated (via the indicated preamble index, e.g., the RA preamble index is associated with a DL RS) in the PDCCH order for which the RA response was not configured to be monitored: the resource of the DL RS resource index/indicator (or PCI or DL-RS+PCI) is stored by the UE in a list of (timing advance reference) DL resources (or PCI or DL-RS+PCI). The network can refer to one or more DL RS resources (or PCI or DL-RS+PCI) in the list and provide the DL RS (or PCI or DL-RS+PCI) with associated TA value to the UE (based on the UEs random access preamble transmissions). This enables the UE to communicate with a (target) cell using the TA value through the provided association (by the list). To enable full mutual understanding of the list, the network may maintain a similar list at the network side (list of DL RSs (or PCI or DL-RS+PCI) and preamble resource indexes The maximum list size can be predefined or configured by the network. Any DL RS in the list may be associated with a PCI value (e.g., SSB reference signal-PCI (cell identity) association pair). Thus, the UE and network device may maintain an association between DL RS and TA (or cell identity/PCI and TA). This information can be used for inter-cell beam management. This information may be used in any further communication (or for cell change or cell switch/handover) with the cell that is associated with TA. If the DCI message or PDCCH order indicates that the UE is not required to monitor RA response (i.e., the TA is not provided as a response to the RA preamble transmission): the network, may provide, a TA value (e.g., associated with a new TAG/TA loop) associated with one of the DL RS/cell in the list; and the entries of the list are based on the DL RS indicated in the PDCCH order (e.g., associated with the PCIs different than target cell). Each entry in the list may have a validity timer. The maximum value of the validity timer can be predefined or configured by the network. A validity timer may be started after successful completion of the RA procedure (and/or when the entry is added). Upon timer expiry/expiration (i.e., the value of validity timer is larger or equal to the maximum value, or alternatively counts down to zero), the entry is removed. If a timer is running associated with the entry of the list, the NW can refer to the entry and provide associated TA value. Upon receiving a new TA value associated with the DL RS (and additionally PCI associated with the DL RS such as an SSB) included in the list, the UE assumes any UL transmission according to the TA associated with the TA loop/TAG ID.

If a network device or serving cell indicates that the UE will monitor RAR for a cell or random access procedure, the UE will receive the TA via RAR, but serving cell that triggered PDCCH order does not know if RA procedure it triggered was successful and when it was completed. Thus, in an example embodiment, the UE may notify (or send a message to serving cell to notify) the serving cell or network device of the successful completion of RA procedure with this candidate target cell. In one another example embodiment, the UE may be configured to notify (or send a message to serving cell to notify) the serving cell or network device of the successful completion of RA procedure (PDCCH ordered RA or CBRA, contention based random access procedure) with a (candidate target) cell. In some examples, the PDCCH order may be used to trigger CBRA procedure. In some examples, the UE may be configured to report the obtained TA of a cell (e.g., TA for a candidate target cell) to the serving cell.

In one embodiment, if the DCI triggers the PDCCH order and the target preamble index (and the associated DL RS e.g., SSB/CSI-RS) for the PRACH transmission is associated with the cell with different PCI than serving cell: the UE is configured to notify the serving cell of the successful completion of RA procedure. The serving cell or network device may include a request to UE for such a report of a successful completion of RA procedure via a new field in the DCI triggering the PDCCH ordered RA procedure. Alternatively, a network (or network device or network node) may configure the UE to report a cell for which UE has obtained a TA (e.g., through a RA procedure). The report may also include the TA value. As an example, the UE may be configured, e.g., using RRC (or RRC+MAC CE or MA CE) to report cells for which UE has obtained a TA value (in other words the cells that UE is uplink time aligned (e.g., cells for which the UE has TA value)). The report may be provided to network (e.g., to network device or network node, serving cell or source cell) upon completing a RA procedure (in which a TA is received) or when UE determines that it has obtained or can consider it to be uplink time aligned to a specific cell or cells. A cell or specific cell(s) may include also serving cell (e.g., in case one or more TA values are supported for one (serving) cell). The request (or configuration) may also indicate whether or not UE should report the successful acquisition of TA/timing for the target cell, for example. If the PDCCH order indicates the UE to monitor RAR response for the triggered RA preamble transmission, UE may determine that it shall report the successful completion of random access procedure to serving cell. UE may indicate in one message (MAC-CE) one or more PCIs (and/or DL RS) for which the PDCCH order is completed and UE has received a TA value. In one further example, the PCIs are cells configured as LLM candidate cells (lower layer mobility). If a UE has indicated a PCI that it has valid TA for the cell, UE is assumed to: the beam application time is based on the known TCI State conditions. In one example, the PDCCH order may trigger a CBRA (contention based random access) procedure (i.e., no RA preamble are reserved specifically). The UE may have been configured by the triggering DCI to report the obtained: TA value, and/or to report an indication that which of cells (e.g., LLM cells) the UE is currently time aligned (has TA values for). The list of cells for which the UE has TA values (time aligned list of cells for the UE), may be supervised or managed by the use of a timer, including dropping or discarding TA values/cells from the list when their respective timers expire (indicating that such TA values are stale or no longer accurate). In some examples, the network (e.g., network node or network device, cell or candidate target cell) that received the RA transmission by UE and determined the TA value associated with the RA transmission/procedure, may send/indicate the TA value to the serving cell. This indication may be provided upon the completion of the RA procedure. As an example, a network node may be configured to signal to another network node a TA value (or an indication that UE is UL time aligned with the cell) associated with a UE (wherein the TA value may have been obtained using RA procedure or determined based on an UL transmission with that cell).

In one embodiment, the network or serving cell/network device may configure UE to update TA for at least one cell (or TRP/transmission reception point) determined based on the set of DL RS) associated with the serving cell PCI or PCI other than serving cell: may trigger PDCCH order to UE and indicate that no RAR response monitoring is required. The transmission updates the TA observed by the one or more target cells (which in turn), and network may provide the TA value to UE when it has determined which cells the UE will be handed over (or for which cells the UE may perform or likely perform cell change). This may be beneficial for UE that it does not need to maintain multiple TAs before the handover.

In one embodiment, the network may configure UE to obtain TA for at least one cell with different PCI than serving cell, and upon obtaining the TA, report the successful obtaining to source cell. In one embodiment, any embodiment above may be conditioned if UE configured with multiple TA values (e.g., multiple TAGs) for a serving cell; and/or, in one embodiment, an RRC configuration may be provided whether the bit field is present or not in the DCI.

Some further examples will be provided.

Example 1. An apparatus, comprising: at least one processor; and at least one memory storing instructions that, when executed by the at least one processor, cause the apparatus at least to: obtain a message instructing the apparatus to trigger or initiate a random access (RA) procedure to access a cell of a network device, the message indicating whether or not the apparatus is to monitor or receive a random access response (RAR) within a RAR window during the triggered random access procedure; and determine whether or not to monitor or receive the RAR within the RAR window based on the indication.

Example 2. The apparatus of example 1, wherein the message comprises downlink control information (DCI) received via a physical downlink control channel (PDCCH).

Example 3. The apparatus of any of examples 1-2, wherein the message comprises a field triggering or causing a physical downlink control channel (PDCCH) order that indicates whether or not the apparatus is monitor or receive the RAR response within the RAR window during the triggered random access procedure initiated via the PDCCH order.

Example 4. The apparatus of example 3, wherein the field comprises at least one of: 1 bit, N bit, a codepoint value, or a value that is used as a table lookup, where N is a positive integer.

Example 5. The apparatus of any of examples 1-4, wherein the instructions, when executed by the at least one processor, cause the apparatus at least to: if the message indicates that the apparatus is not to monitor or receive the RAR within the RAR window during the triggered random access procedure, determine or assume, by the apparatus, that the triggered random access procedure is successfully completed after a RA preamble transmission from the apparatus to the cell of the network device for the triggered random access procedure.

Example 6. The apparatus of any of examples 1-5, wherein the instructions, when executed by the at least one processor, cause the apparatus at least to: if the indication indicates that a random access preamble resource is configured not to be associated with the RAR, determine or assume that the triggered random access procedure is successfully completed after a random access (RA) preamble transmission corresponding to the random access preamble resource and from the apparatus to the cell of the network device for the triggered random access procedure.

Example 7. The apparatus of any of examples 3-6, wherein the instructions, when executed by the at least one processor, cause the apparatus at least to: obtain a downlink reference signal (DL RS) indicated in the PDCCH order; and determine, based on the DL RS, whether or not the RAR is configured to be monitored or received by the apparatus within the RAR window during the triggered random access procedure.

Example 8. The apparatus of any one of examples 3-7, wherein the instructions, when executed by the at least one processor, cause the apparatus at least to: store a resource associated with the DL RS in a list of downlink resources.

Example 9. The apparatus of any of examples 3-8, wherein the list of downlink resources comprises one or more timing advance (TA) references or values.

Example 10. The apparatus of any of examples 3-9, wherein a size of the list of downlink resources is predefined or configured by the network device.

Example 11. The apparatus of any of examples 8-10, wherein the list of downlink resources each is associated with a corresponding physical cell identity (PCI) value.

Example 12. The apparatus of any of examples 8-11, wherein the list of downlink resources each is associated with a corresponding validity timer.

Example 13. The apparatus of example 12, wherein a maximum value of each of the validity timers is predefined or configured by the network device.

Example 14. The apparatus of any of examples 8-13, wherein the validity timers each are started after successful completion of the triggered random access procedure.

Example 15. The apparatus of any of examples 8-14, wherein the instructions, when executed by the at least one processor, cause the apparatus at least to: if the indication indicates that the apparatus is not to monitor or receive the RAR within the RAR window during the triggered random access procedure, acquire a timing advance (TA) value associated with at least one downlink resource in the list of downlink resources for the triggered random access procedure.

Example 16. The apparatus of example 15, wherein the acquired timing advance (TA) value is different from a TA value currently in use in the cell of the network device for the triggered random access procedure.

Example 17. The apparatus of any of examples 15-16, wherein the instructions, when executed by the at least one processor, cause the apparatus at least to: upon acquiring the timing advance (TA) value, perform one or more subsequent uplink transmissions to the cell of the network device in accordance with the acquired TA value.

Example 18. The apparatus of any of examples 3-17, wherein the instructions, when executed by the at least one processor, cause the apparatus at least to: if the indication indicates that the downlink control information (DCI) triggers or causes the PDCCH order and a target downlink reference signal (DL RS) for the random access (RA) preamble transmission is associated with a different cell than that of the network device, indicate to the cell of the network device, a successful completion of the triggered random access procedure.

Example 19. The apparatus of any of examples 3-18, wherein the instructions, when executed by the at least one processor, cause the apparatus at least to: if the PDCCH order indicates the apparatus to monitor or receive the RAR for the random access (RA) preamble transmission, determine whether to report, to the cell of the network device, a successful completion of the triggered random access procedure.

Example 20. The apparatus of example 19, wherein the instructions, when executed by the at least one processor, cause the apparatus at least to: indicate, to the cell of the network device, one or more physical cell identities (PCIs) for which at least one of the RA procedure triggered by PDCCH order is completed or a timing advance (TA) value is received.

Example 21. The apparatus of example 19, wherein the one or more physical cell identities (PCIs) are indicated via a media access control-control element (MAC-CE).

Example 22. The apparatus of any of examples 1-21, wherein the message comprises: a random access preamble resource; and a physical downlink control channel (PDCCH) order instructing the apparatus to perform the triggered random access procedure; wherein the PDCCH order indicates, either explicitly or implicitly, whether or not the apparatus is to monitor or receive a random access response (RAR) within a RA response window during the triggered random access procedure.

Example 23. The apparatus of example 22, wherein the PDCCH order includes a field set to a value to explicitly indicate whether or not the apparatus is to monitor or receive a random access response (RAR) within a RA response window during the triggered random access procedure.

Example 24. The apparatus of example 22, wherein: a first list of random access preamble resources are associated with monitoring or receiving a random access response (RAR) within a random access (RA) response window during the triggered random access procedure; and a second list of random access preamble resources are associated with not monitoring or receiving a random access response (RAR) within a random access (RA) response window during the triggered random access procedure; and wherein the message includes a random access preamble resource from the second list of random access preambles to implicitly indicate that the apparatus is not to monitor or receive a random access response (RAR) within a random access (RA) response window during the triggered random access procedure.

Example 25. A method comprising: obtaining, by a user device, a message instructing the user device to trigger or initiate a random access (RA) procedure to access a cell of a network device, the message indicating whether or not the apparatus is to monitor or receive a random access response (RAR) within a RAR window during the triggered random access procedure; and determining, by the user device, whether or not to monitor or receive the RAR within the RAR window based on the indication.

Example 26. The method of example 25, wherein the message comprises downlink control information (DCI) received via a physical downlink control channel (PDCCH).

Example 27. The method of any of examples 25-26, wherein the message comprises a field triggering or causing a physical downlink control channel (PDCCH) order that indicates whether or not the apparatus is monitor or receive the RAR response within the RAR window during the triggered random access procedure initiated via the PDCCH order.

Example 28. The method of example 27, wherein the field comprises at least one of: 1 bit, N bit, a codepoint value, or a value that is used as a table lookup, where N is a positive integer.

Example 29. The method of any of examples 25-28, comprising: if the message indicates that the apparatus is not to monitor or receive the RAR within the RAR window during the triggered random access procedure, determining or assuming, by the apparatus, that the triggered random access procedure is successfully completed after a RA preamble transmission from the apparatus to the cell of the network device for the triggered random access procedure.

Example 30. The method of any of examples 25-29, comprising: if the indication indicates that a random access preamble resource is configured not to be associated with the RAR, determining or assuming that the triggered random access procedure is successfully completed after a random access (RA) preamble transmission corresponding to the random access preamble resource and from the apparatus to the cell of the network device for the triggered random access procedure.

Example 31. The method of any of examples 25-30, comprising: obtaining a downlink reference signal (DL RS) indicated in the PDCCH order; and determining, based on the DL RS, whether or not the RAR is configured to be monitored or received by the apparatus within the RAR window during the triggered random access procedure.

Example 32. The method of any of examples 27-31, comprising: storing a resource associated with the DL RS in a list of downlink resources.

Example 33. The method of any of examples 27-32, wherein the list of downlink resources comprises one or more timing advance (TA) references or values.

Example 34. The method of any of examples 27-33, wherein a size of the list of downlink resources is predefined or configured by the network device.

Example 35. The method of any of examples 32-34, wherein the list of downlink resources each is associated with a corresponding physical cell identity (PCI) value.

Example 36. The method of any of examples 32-35, wherein the list of downlink resources each is associated with a corresponding validity timer.

Example 37. The apparatus of example 36, wherein a maximum value of each of the validity timers is predefined or configured by the network device.

Example 38. The method of any of examples 32-37, wherein the validity timers each are started after successful completion of the triggered random access procedure.

Example 39. The method of any of examples 32-38, comprising: if the indication indicates that the apparatus is not to monitor or receive the RAR within the RAR window during the triggered random access procedure, acquiring a timing advance (TA) value associated with at least one downlink resource in the list of downlink resources for the triggered random access procedure.

Example 40. The method of example 39, wherein the acquired timing advance (TA) value is different from a TA value currently in use in the cell of the network device for the triggered random access procedure.

Example 41. The method of any of examples 39-40, comprising: upon acquiring the timing advance (TA) value, performing one or more subsequent uplink transmissions to the cell of the network device in accordance with the acquired TA value.

Example 42. The method of any of examples 27-41, comprising: if the indication indicates that the downlink control information (DCI) triggers or causes the PDCCH order and a target downlink reference signal (DL RS) for the random access (RA) preamble transmission is associated with a different cell than that of the network device, indicating to the cell of the network device, a successful completion of the triggered random access procedure.

Example 43. The method of any of examples 27-42, comprising: if the PDCCH order indicates the apparatus to monitor or receive the RAR for the random access (RA) preamble transmission, determining whether to report, to the cell of the network device, a successful completion of the triggered random access procedure.

Example 44. The method of example 43, comprising: indicating, to the cell of the network device, one or more physical cell identities (PCIs) for which at least one of the RA procedure triggered by PDCCH order is completed or a timing advance (TA) value is received.

Example 45. The method of example 44, wherein the one or more physical cell identities (PCIs) are indicated via a media access control-control element (MAC-CE).

Example 46. The method of any of examples 25-45, wherein the message comprises: a random access preamble resource; and a physical downlink control channel (PDCCH) order instructing the apparatus to perform the triggered random access procedure; wherein the PDCCH order indicates, either explicitly or implicitly, whether or not the apparatus is to monitor or receive a random access response (RAR) within a RA response window during the triggered random access procedure.

Example 47. The method of example 46, wherein the PDCCH order includes a field set to a value to explicitly indicate whether or not the apparatus is to monitor or receive a random access response (RAR) within a RA response window during the triggered random access procedure.

Example 48. The apparatus of example 46, wherein: a first list of random access preamble resources are associated with monitoring or receiving a random access response (RAR) within a random access (RA) response window during the triggered random access procedure; and a second list of random access preamble resources are associated with not monitoring or receiving a random access response (RAR) within a random access (RA) response window during the triggered random access procedure; and wherein the message includes a random access preamble resource from the second list of random access preambles to implicitly indicate that the apparatus is not to monitor or receive a random access response (RAR) within a random access (RA) response window during the triggered random access procedure.

Example 49. An apparatus comprising: means for obtaining, by a user device, a message instructing the user device to trigger or initiate a random access (RA) procedure to access a cell of a network device, the message indicating whether or not the apparatus is to monitor or receive a random access response (RAR) within a RAR window during the triggered random access procedure; and means for determining, by the user device, whether or not to monitor or receive the RAR within the RAR window based on the indication.

Example 50. A non-transitory computer-readable storage medium comprising instructions stored thereon that, when executed by at least one processor, are configured to cause a computing system to: obtain a message instructing the apparatus to trigger or initiate a random access (RA) procedure to access a cell of a network device, the message indicating whether or not the apparatus is to monitor or receive a random access response (RAR) within a RAR window during the triggered random access procedure; and determine whether or not to monitor or receive the RAR within the RAR window based on the indication.

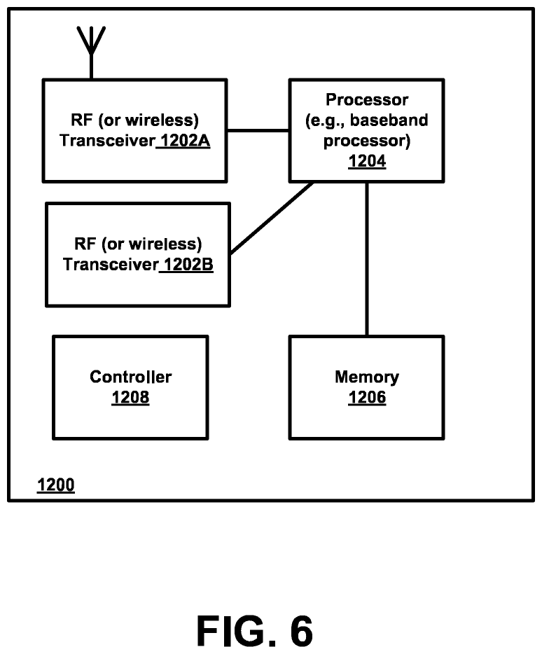

FIG. 6 is a block diagram of a wireless station or node (e.g., UE, user device, AP, BS, eNB, gNB, RAN node, network node, TRP, or other node) 1200 according to an example embodiment. The wireless station 1200 may include, for example, one or more (e.g., two as shown in FIG. 6) RF (radio frequency) or wireless transceivers 1202A, 1202B, where each wireless transceiver includes a transmitter to transmit signals and a receiver to receive signals. The wireless station also includes a processor or control unit/entity (controller) 1204 to execute instructions or software and control transmission and receptions of signals, and a memory 1206 to store data and/or instructions.

Processor 1204 may also make decisions or determinations, generate frames, packets or messages for transmission, decode received frames or messages for further processing, and other tasks or functions described herein. Processor 1204, which may be a baseband processor, for example, may generate messages, packets, frames or other signals for transmission via wireless transceiver 1202 (1202A or 1202B). Processor 1204 may control transmission of signals or messages over a wireless network, and may control the reception of signals or messages, etc., via a wireless network (e.g., after being down-converted by wireless transceiver 1202, for example). Processor 1204 may be programmable and capable of executing software or other instructions stored in memory or on other computer media to perform the various tasks and functions described above, such as one or more of the tasks or methods described above. Processor 1204 may be (or may include), for example, hardware, programmable logic, a programmable processor that executes software or firmware, and/or any combination of these. Using other terminology, processor 1204 and transceiver 1202 together may be considered as a wireless transmitter/receiver system, for example.

In addition, referring to FIG. 6, a controller (or processor) 1208 may execute software and instructions, and may provide overall control for the station 1200, and may provide control for other systems not shown in FIG. 6, such as controlling input/output devices (e.g., display, keypad), and/or may execute software for one or more applications that may be provided on wireless station 1200, such as, for example, an email program, audio/video applications, a word processor, a Voice over IP application, or other application or software.

In addition, a storage medium may be provided that includes stored instructions, which when executed by a controller or processor may result in the processor 1204, or other controller or processor, performing one or more of the functions or tasks described above.

According to another example embodiment, RF or wireless transceiver(s) 1202A/1202B may receive signals or data and/or transmit or send signals or data. Processor 1204 (and possibly transceivers 1202A/1202B) may control the RF or wireless transceiver 1202A or 1202B to receive, send, broadcast or transmit signals or data.

Embodiments of the various techniques described herein may be implemented in digital electronic circuitry, or in computer hardware, firmware, software, or in combinations of them. Embodiments may be implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Embodiments may also be provided on a computer readable medium or computer readable storage medium, which may be a non-transitory medium. Embodiments of the various techniques may also include embodiments provided via transitory signals or media, and/or programs and/or software embodiments that are downloadable via the Internet or other network(s), either wired networks and/or wireless networks. In addition, embodiments may be provided via machine type communications (MTC), and also via an Internet of Things (IOT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer, or it may be distributed amongst a number of computers.

Furthermore, embodiments of the various techniques described herein may use a cyber-physical system (CPS) (a system of collaborating computational elements controlling physical entities). CPS may enable the embodiment and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various embodiments of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, embodiments may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments may be implemented in a computing system that includes a back-end component, e.g., as a data server, or that includes a middleware component, e.g., an application server, or that includes a front-end component, e.g., a client computer having a graphical user interface or a Web browser through which a user can interact with an embodiment, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described embodiments have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

1-50. (canceled)

51. An apparatus for communication, comprising:
at least one processor; and
at least one memory storing instructions that, when executed by the at least one processor, cause the apparatus at least to:
obtain a message instructing the apparatus to trigger or initiate a random access (RA) procedure to access a cell of a network device, the message indicating whether or not the apparatus is to monitor or receive a random access response (RAR) within a RAR window during the triggered random access procedure; and
determine whether or not to monitor or receive the RAR within the RAR window based on the indication;
wherein the message comprises:
a random access preamble resource; and
a physical downlink control channel (PDCCH) order instructing the apparatus to perform the triggered random access procedure; and
wherein the PDCCH order indicates, either explicitly or implicitly, whether or not the apparatus is to monitor or receive a random access response (RAR) within a RA response window during the triggered random access procedure, wherein:
a first list of random access preamble resources are associated with monitoring or receiving a random access response (RAR) within a random access (RA) response window during the triggered random access procedure; and
a second list of random access preamble resources are associated with not monitoring or receiving a random access response (RAR) within a random access (RA) response window during the triggered random access procedure; and
wherein the message includes a random access preamble resource from the second list of random access preambles to implicitly indicate that the apparatus is not to monitor or receive a random access response (RAR) within a random access (RA) response window during the triggered random access procedure.

52. The apparatus of claim 51, wherein the message comprises downlink control information (DCI) received via a physical downlink control channel (PDCCH).

53. The apparatus of claim 51, wherein the message comprises a field triggering or causing a physical downlink control channel (PDCCH) order that indicates whether or not the apparatus is monitor or receive the RAR response within the RAR window during the triggered random access procedure initiated via the PDCCH order.

54. The apparatus of claim 53, wherein the field comprises at least one of: 1 bit, N bit, a codepoint value, or a value that is used as a table lookup, where N is a positive integer.

55. The apparatus of claim 51, wherein the instructions, when executed by the at least one processor, cause the apparatus at least to:
if the message indicates that the apparatus is not to monitor or receive the RAR within the RAR window during the triggered random access procedure, determine or assume, by the apparatus, that the triggered random access procedure is successfully completed after a RA preamble transmission from the apparatus to the cell of the network device for the triggered random access procedure.

56. The apparatus of claim 51, wherein the instructions, when executed by the at least one processor, cause the apparatus at least to:
if the indication indicates that a random access preamble resource is configured not to be associated with the RAR, determine or assume that the triggered random access procedure is successfully completed after a random access (RA) preamble transmission corresponding to the random access preamble resource and from the apparatus to the cell of the network device for the triggered random access procedure.

57. The apparatus of claim 53, wherein the instructions, when executed by the at least one processor, cause the apparatus at least to:
obtain a downlink reference signal (DL RS) indicated in the PDCCH order; and
determine, based on the DL RS, whether or not the RAR is configured to be monitored or received by the apparatus within the RAR window during the triggered random access procedure.

58. The apparatus of claim 53, wherein the instructions, when executed by the at least one processor, cause the apparatus at least to:
store a resource associated with the DL RS in a list of downlink resources.

59. The apparatus of claim 53, wherein the list of downlink resources comprises one or more timing advance (TA) references or values.

60. The apparatus of claim 53, wherein a size of the list of downlink resources is predefined or configured by the network device.

61. The apparatus of claim 58, wherein the list of downlink resources each is associated with a corresponding physical cell identity (PCI) value.

62. The apparatus of claim 58, wherein the list of downlink resources each is associated with a corresponding validity timer.

63. The apparatus of claim 62, wherein a maximum value of each of the validity timers is predefined or configured by the network device.

64. The apparatus of claim 58, wherein the validity timers each are started after successful completion of the triggered random access procedure.

65. The apparatus of claim 58, wherein the instructions, when executed by the at least one processor, cause the apparatus at least to:
if the indication indicates that the apparatus is not to monitor or receive the RAR within the RAR window during the triggered random access procedure, acquire a timing advance (TA) value associated with at least one downlink resource in the list of downlink resources for the triggered random access procedure.

66. The apparatus of claim 65, wherein the acquired timing advance (TA) value is different from a TA value currently in use in the cell of the network device for the triggered random access procedure.

67. The apparatus of claim 65, wherein the instructions, when executed by the at least one processor, cause the apparatus at least to:
upon acquiring the timing advance (TA) value, perform one or more subsequent uplink transmissions to the cell of the network device in accordance with the acquired TA value.

68. The apparatus of claim 53, wherein the instructions, when executed by the at least one processor, cause the apparatus at least to:
if the indication indicates that the downlink control information (DCI) triggers or causes the PDCCH order and a target downlink reference signal (DL RS) for the random access (RA) preamble transmission is associated with a different cell than that of the network device, indicate to the cell of the network device, a successful completion of the triggered random access procedure.

69. The apparatus of claim 53, wherein the instructions, when executed by the at least one processor, cause the apparatus at least to:
if the PDCCH order indicates the apparatus to monitor or receive the RAR for the random access (RA) preamble transmission, determine whether to report, to the cell of the network device, a successful completion of the triggered random access procedure.

70. The apparatus of claim 69, wherein the instructions, when executed by the at least one processor, cause the apparatus at least to:
indicate, to the cell of the network device, one or more physical cell identities (PCIs) for which at least one of the RA procedure triggered by PDCCH order is completed or a timing advance (TA) value is received.
